(19) United States
(12) Patent Application Publication
(10) Pub. No.: US 2004/0079215 A1
(43) Pub. Date: Apr. 29, 2004

(54) Straight guide

(76) Inventor: Iwan Yves Vlaar, Rotterdam (NL)

Correspondence Address: BANNER & WITCOFF, 1001 G STREET N W, SUITE 1100, WASHINGTON, DC, 20001, US

(21) Appl. No.: 10/362,771

(22) PCT Filed: Aug. 27, 2001
(86) PCT No.: PCT/NL01/00624

(30) Foreign Application Priority Data
Aug. 31, 2000 (NL) 1016067

(51) Int. Cl. B26D 5/00

(52) U.S. Cl. 83/745; 83/821; 30/294

(57) ABSTRACT

The invention relates to an elongate guide (4) for guiding a tool (1) in the longitudinal direction of the guide as the tool performs an operation extending along a straight line on a workpiece (3), wherein the straight line extends parallel to the longitudinal direction of the guide, wherein the guide can be divided into a number of mutually connectable elements. In order to prevent play, a force-transmitting coupling is preferred. It is of course possible to apply a screw connection as force-transmitting coupling, but an attractive embodiment results when the coupling comprises a male part (17) mounted on a first end of the element and a female (18) of the female part extending substantially in the longitudinal direction of the guide is adapted to be in contact at least at two points with an outer wall (19) of the male part of the coupling, and that the coupling is provided with a pressing element (22) adapted to press the inner wall and the outer wall and the outer wall against each other.

The invention relates to an elongate guide for guiding a tool in the longitudinal direction of the guide as the tool performs an operation extending along a straight line on a workpiece, wherein the straight line extends parallel to the longitudinal direction of the guide.

Such a guide is for instance formed by a metal rule or by a straight wooden lat used in guiding for instance a sawing machine during sawing of a board of wood-like material.

Not every user, and certainly not every user in the “DIY” segment, has at his disposal such a long rule or a long straight lat. There is therefore a need for such a guide which can preferably be sold simultaneously with a saw or the like.

Sawing machines are usually used to saw board material, wherein the longest dimension for sawing amounts to about two and a half metres. The supply together with a saw of a rule or guide of such a dimension meets with logistical problems.

The object of the present invention is therefore to provide such a guide which can be easily supplied with for instance a saw.

This objective is achieved in that the guide can be divided into a number of mutually connectable elements.

According to a first embodiment the elements are mutually connected by hinges. This provides the option of folding such a guide together so that a unit is obtained with a longest dimension which is no larger than the longest dimension of such an element.

According to a specific preferred embodiment the rotation axis of the hinge extends transversely of the longitudinal direction of the guide and parallel to the upper surface of the workpiece.

This avoids hinges with a rotation axis perpendicular to the upper surface of the workpiece; such hinges could after all move under the effect of forces acting on the guide, whereby the straightness of the guide would be lost.

According to another preferred embodiment, elements can be separated by a coupling to form separate elements.

This provides the option of supplying the coupling in form-fitting or force-transmitting manner.

In order to prevent play, a force-transmitting coupling is preferred.

It is of course possible to apply a screw connection as force-transmitting coupling, but an attractive embodiment results when the coupling comprises a male part mounted on a first end of the element and a female part mounted on the second end of the element, wherein an inner wall of the female part extending substantially in the longitudinal direction of the guide is adapted to be in contact at least at two points with an outer wall of the male part of the coupling, and the coupling is provided with an urging element adapted to urge the inner wall and the outer wall against each other.

This embodiment provides the option of manufacturing all components of the relevant element integrally.

The same advantage applies to the measure that the coupling comprises a male part mounted on a first end of the element and a female part mounted on the second end of the element, wherein the female part of the coupling comprises at least two points of contact adapted to be in contact, when the coupling is closed, with an opposite wall of the male part in the longitudinal direction, and wherein the line connecting both points of contact has a component in the transverse direction and the coupling is provided with an urging element adapted to urge at least one point of the inner wall of the female part against the outer wall of the male part.

A larger contact basis between the separate elements is hereby obtained, so that there is less chance of relative movement.

The measure that the coupling comprises a wedge which is connected flexibly to one of the parts and which in the coupled state contacts the male part and which under the pressure of a flexible connection urges the coupling parts against each other, results in a structurally attractive embodiment.

Another embodiment of a force-transmitting coupling is formed by the configuration of a LEGO brick, wherein for instance one coupling part comprises studs and the other coupling part comprises clamping engaging elements for placing into engagement with the studs from above.

Because much sawing must take place along a line extending perpendicularly of an edge of a workpiece, it is attractive when the edge is used as reference. The measure that at least one of the elements is provided with a coupling part adapted for connecting to an element extending perpendicularly of the guide provides the advantage here that the guide can be used as set square.

The guide is therefore preferably adapted to guide a sawing machine, for instance a circular saw.

The invention also relates to a combination of a guide according to any of the foregoing claims and a sawing machine, wherein the sawing machine is provided with at least a first and a second engaging element which are relatively displaced in the sawing direction and which engage on a part of a first rebate forming part of the guide.

Correct guiding of the saw is hereby obtained.

If however the guide is provided with a second rebate facing in a direction opposite to that of the first rebate, and the sawing machine is provided with a third engaging element for engaging the rebate between the first and the second engaging element, the guide can absorb forces acting in both directions. Structurally, such a configuration is the easiest to embody, in that a ridge is arranged on the guide and in that the rebates are formed by the two sides of the ridge. The problem of a groove, i.e. the accumulation of dirt and sawdust, is hereby avoided.

Another preferred embodiment teaches that the sawing machine is adapted to move with its sole over the workpiece. It is hereby possible to suffice with a simple guide.

A final embodiment teaches that the guide extends transversely of the sawing direction to a point close to the saw-blade.

Splintering of the saw cut is hereby prevented as far as possible.

The present invention will be elucidated hereinbelow with reference to the annexed figures, in which:

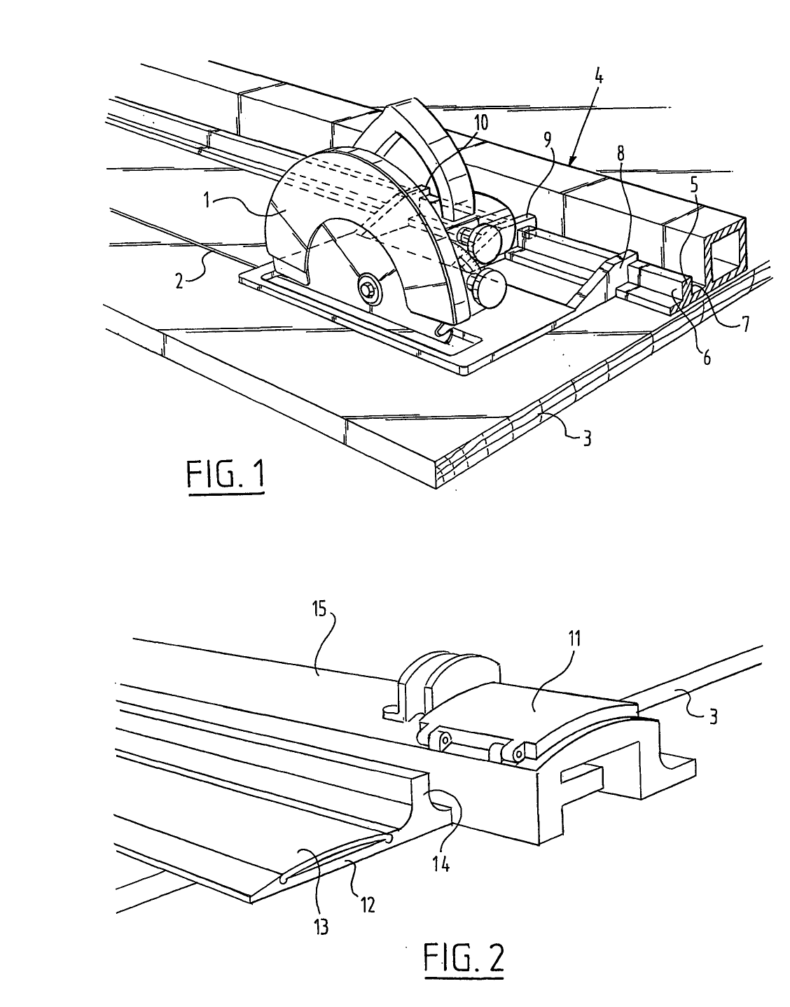

FIG. 1 shows a perspective view of a combination of a circular saw and a guide according to the present invention;

FIG. 2 is a schematic perspective, broken-away view of a second embodiment of a guide according to the present invention;

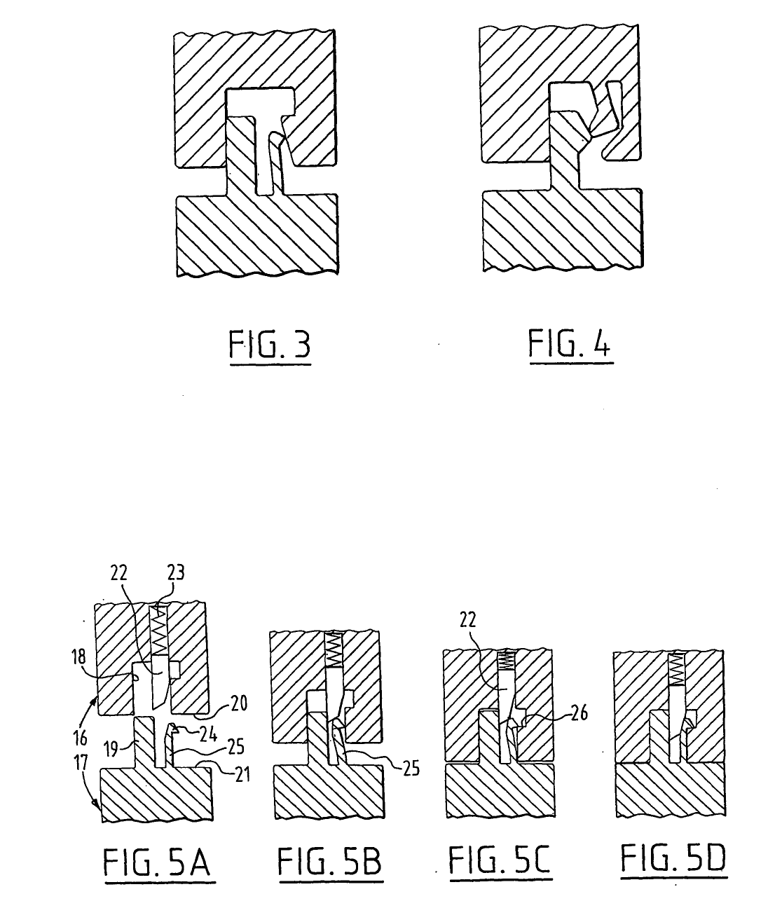

FIGS. 3 and 4 show cross-sections of geometric variants of the coupling according to the invention; and

FIGS. 5A-5D are horizontal cross-sectional views of the coupling shown in FIG. 4.

FIG. 1 shows a circular saw 1 which is used to make a saw cut 2 in a board of wood-like material 3. In order to ensure that the saw cut runs straight, use is made of a guide designated as a whole with 4. The guide is formed by a profile which is manufactured for instance from plastic but which can likewise be manufactured from another suitable material, for instance aluminium.

The profile is provided with a ridge 5 provided on either side with a rebate 6 respectively 7. For guiding purposes the saw 1 is provided with three arms 8, 9, 10 respectively. Arms 8 and 10 are provided with a contact surface which engages on the rebate 6 directed toward the machine side of ridge 5, while the arm 9 intermediate arms 8 and 10 is provided with a contact surface adapted to contact rebate 7.

As a consequence of these measures an efficient guiding of the saw is obtained, so that a straight saw cut will easily be created, even by less experienced users.

It is also possible to combine the contact surfaces of the arms to form a tunnel-like profile extending over the ridge along a length in the order of magnitude of the diameter of the saw blade.

As already stated in the preamble, the guide takes a divided form in respect of logistical problems.

FIG. 2 shows an example of a further embodiment of the guide. This guide is provided with a coupling, a control element 11 of which is shown. The profile of the guide further comprises a base 12 extending under a significant part of the saw. The advantage of this measure is that the base to a great extent prevents splinter-forming in the saw cut. The saw will further have to be adapted here to slide over a relevant part of the base, which can be achieved for instance by arranging a slide surface 13 on the profile.

As in the previous embodiment, the present profile is provided with a ridge 14, as well as with an elevation 15. This elevation 15 serves to increase the rigidity of the profile, but also to provide space for the couplings used to mutually connect the guide elements.

An embodiment of such a coupling is shown in FIGS. 3 and 4.

The coupling shown in FIG. 3 comprises a female part 16 arranged on one side of an element and a male part 17 arranged on the other side. Female part 16 is provided with an inner wall 18 and the male part with an outer wall 19. Both wall parts 18 and 19 are adapted to lie against each other when the coupling is closed so as to obtain the largest possible contact basis.

The female part 16 of the coupling further comprises a transverse surface 20 and the male part of the coupling a transverse surface 21. These transverse surfaces are also intended to rest against each other and thus enlarge the contact basis between the guide parts.

The elements described up to this point are used to enclose and pre-position the coupling by means of friction.

In order to obtain a force transmission use is made of a wedge 24 which is connected to the guide part by a flexible lip 25. Wedge 24 is adapted to engage behind a nose 26 connected to the other side of the profile part. When wedge 24 has engaged behind nose 26, the lock 22 will push wedge 24 into this position, so that a firm, force-transmitting connection is obtained. Owing to the inclining face of the wedge the force transmission acts not only in the transverse direction but also in longitudinal direction.

It will be apparent that diverse variations can be made to the coupling mechanism; in FIG. 4 the lip 25 of wedge 24 is thus connected to the female part. In this case the nose 26 is mounted on the male part. It is otherwise also possible for instance to form the pressing body with a screw of the like. Other geometries can moreover be envisaged.

FIG. 5 shows an embodiment of another coupling which can form a force-transmitting connection. A closing element 22 is added here.

Closing element 22 has the function of locking the coupling, so that it cannot be pulled open unintentionally. The closing element furthermore increases the rigidity. For operation of the closing element use is made of the element 11 shown in FIG. 2. It is finally noted that the guide elements can also be used for other purposes; they can for instance together form part of a case for storing and transporting the saw.

1. Elongate guide for guiding a tool in the longitudinal direction of the guide as the tool performs an operation extending along a straight line on a workpiece, wherein the straight line extends parallel to the longitudinal direction of the guide, wherein the guide can be divided into a number of mutually connectable elements, which can be separated by a form-fitting coupling to form separate elements, wherein the coupling only comprises parts which form a part of the elements, characterized in that the coupling parts comprise faces adapted to transfer transvers forces parallel to the workpiece.

2. Guide as claimed inclaim 1, characterized in that the coupling comprises a male part mounted on a first end of the element and a female part mounted on the second end of the element, wherein an inner wall of the female part extending substantially in the longitudinal direction of the guide is adapted to be in contact at least at two points with an outer wall of the male part of the coupling, and that the coupling is provided with an urging element adapted to urge the inner wall and the outer wall against each other.

3. Guide as claimed in claim 1, characterized in that the coupling comprises a male part mounted on a first end of the element and a female part mounted on the second end of the element, wherein the female part of the coupling comprises at least two points of contact adapted to be in contact, when the coupling is closed, with an opposite wall of the male part in the longitudinal direction, and wherein the line connecting both points of contact has a component in the transverse direction and that the coupling is provided with an urging element adapted to urge at least one point of the inner wall of the female part against the outer wall of the male part.

4. Guide as claimed in claim 2 or 3, characterized in that the pressing element comprises a wedge which is connected flexibly to one of the parts and which in the coupled state of the coupling contacts the male part and which under the pressure of the flexible connection urges the coupling parts against each other.

5. Guide as claimed in claim 2 or 3, characterized in that the pressing element comprises a wedge which is connected flexibly to one of the parts and which in the coupled state of the coupling contacts the male part and which, after passing over a nose mounted on the other part, exerts a force on the male part under the influence of the nose.

6. Guide as claimed in claim 4 or 5, characterized in that the pressing element comprises a closing element which is movable substantially in the longitudinal direction of the guide relative to the relevant element and which is adapted to enclose the wedge behind a nose arranged on the relevant element.

7. Guide as claimed in any of the claims 1-6, characterized in that at least one of the elements is provided with a coupling part adapted for connecting to an element extending perpendicularly of the guide.

8. Guide as claimed in any of the foregoing claims, characterized in that the guide is adapted to guide a sawing machine, for instance a circular saw.

9. Guide as claimed in any of the foregoing claims, characterized in that the guide is provided on its underside with a layer increasing the friction with the surface.

10. Combination of a guide as claimed in claim 8 and a sawing machine, characterized in that the sawing machine is provided with at least a first and a second engaging element which are relatively displaceable in the sawing direction and which engage on a part of a first rebate forming part of the guide.

11. Combination as claimed in claim 10, characterized in that the guide is provided with a second rebate facing in a direction opposite to that of the first rebate, and that the sawing machine is provided with a third engaging element for engaging the rebate between the first and the second engaging element.

12. Combination as claimed in claim 10 or 11, characterized in that a ridge is arranged on the guide and that the rebates are formed by the two sides of the ridge.

13. Combination as claimed in claim 10, 11 or 12, characterized in that the sawing machine is adapted to move with at least a part of its sole over the workpiece.

14. Combination as claimed in any of the claims 10-13, characterized in that the guide extends transversely of the sawing direction to a point a short distance from the saw blade.
